(19) United States
(12) Patent Application Publication
(10) Pub. No.: US 2013/0311316 A1
(43) Pub. Date: Nov. 21, 2013

(54) Computerized Method For Initiating a Group Buy

(71) Applicant: Fook Fah YAP, Seattle, WA (US)

(72) Inventor: Fook Fah YAP, Seattle, WA (US)

(21) Appl. No.: 13/633,314

(22) Filed: Oct. 2, 2012

Related U.S. Application Data
(60) Provisional application No. 61/648,787, filed on May 18, 2012.

(51) Int. Cl. G06Q 30/00

(52) U.S. Cl. 705/26.2

(57) ABSTRACT

A method for organizing a group buy organizes a group of buyers and a seller through a website. The seller is able to list any number of items in each group buy, providing sale parameters for each of the items. Once the items are listed, buyers may enter the group buy to place bids on any or all of the listed items. The buyers may choose to bid different amounts on each item, as well as a purchase quantity for each item. Periodically a system will review the bids submitted by the buyers, forming groups to determine the highest profit that can be made based on different combinations of bids submitted by the buyers. The system calculates a highest potential profit for each item being offered and then sums said potential profits for a total profit. The group buy ends successfully if the sale parameters have been met.

The current application claims a priority to the U.S. Provisional Patent application Ser. No. 61/648,787 filed on May 18, 2012.

### FIELD OF THE INVENTION

The present invention relates generally to the purchase of goods. More particularly, the invention relates to a method of selling goods called group or collective buying which has the advantage of providing the goods at significantly reduced prices provided that a minimum number of customers make the purchase or a minimum quantity of items are sold.

### BACKGROUND OF THE INVENTION

Purchasing goods is an integral part of everyday life all around the world. Many different methods for doing so exist, such as a simple exchange of a fixed amount of currency per item such as in a grocery store, bartering, bulk purchasing, and auctions.

Group buying has recently appeared online in numerous forms, but generally it resembles a process known as tuangou buying which takes place in China. In tuangou buying, an item must be bought for a minimum amount of currency or quantity for the transaction to take place at all. Bulk purchasing, which is when a vendor sells a large quantity of a product for a price that is lower than what the total would be if each item were sold individually, is advantageous to the seller because although the total profit gained from each item is lower, the profit is made much more rapidly than individual sales, allowing the seller to re-invest the profit from those items immediately and grow their business faster than if the items were sold individually over a longer period of time.

Individuals often do not have the resources or the need to purchase in bulk, so consumers usually buy only one of a product at a time (depending on the product, of course). Group buying allows individuals to take advantage of bulk pricing by essentially chipping in to buy a large quantity of items at a bulk discount price, which has the effect that each individual gets their item at a lower price than if they had just bought one on their own.

Methods of group buying currently exist in many different forms. What makes this invention unique is that it automatically groups bidders based on the dollar amount of their bid. The system checks if the group with the highest bid meets the target profit. If it doesn't, the system moves to the group with the next highest bid and includes the group with the higher bid in it so that they all pay the lower price. When the target profit is reached, all the groups with a bid greater than or equal to the bid of the group that satisfies the target profit requirement pay the same amount for the item, which is the amount of the lowest bid in the group that satisfies the profit target. This method allows the seller to achieve not only the maximum profit for the sale as a whole, but the maximum profit per item. The method is also unique because the bids are secret, so only the individual buyer and the seller are aware of them. Each customer is also anonymous except to the seller. This prevents the buyers from collaborating to achieve a lower sale price.

The present invention is unique from prior art in that it involves only one seller instead of groups of sellers, automatically groups bidders by dollar amount of bids, and continually updates its parameters to include more bidders if the current group does not meet the target profit value. It allows the system to pick a buying group which meets the target profit value and allows each bidder in the group to pay the lowest bid price in that group.

It is therefore an object of the present invention to provide a method of group buying which maximizes the profit gained by the seller by having buyers submit secret bids, which are then put through an algorithm which groups the bidders by dollar amount to select the sale price until a target profit is met. If the target profit is not met within the time allotted, the sale is not completed.

### BRIEF DESCRIPTION OF THE DRAWINGS

FIG. 1 is a flowchart diagram of the process overview that details the interactions among the customer, group buy website and seller to close the group buy deal utilized by the method as per the current embodiment of this invention.

FIG. 2 is a flowchart diagram of the stepwise process the customer undergoes in order to participate in the group buy as per the current embodiment of this invention.

FIG. 3 is a flowchart diagram of the stepwise process the seller undergoes to participate in the group buy as per the current embodiment of this invention.

FIG. 4 is a flowchart diagram of the stepwise process the group buy website undergoes in order to process the group buy as per the current embodiment of this invention.

FIG. 5 is a flowchart diagram of the stepwise process the customer undergoes in order to revise or cancel a group buy bid as per the current embodiment of this invention.

FIG. 6 is a flowchart diagram of the stepwise process illustrating what must take place in order to close a group buy deal as per the current embodiment of this invention.

FIG. 7 is a table illustrating the method the website uses to determine the sale price for a given item.

FIG. 8 is a table illustrating the calculation of the group buy performance for a group buy deal as per the current embodiment of this invention.

FIG. 9 is a table generally illustrating the data a seller enters into the group buy back-end website in order to set up a group buy as per the current embodiment of this invention.

FIG. 10 is a table generally illustrating the data customers enter on the group buy website in order to place a bid on an item as per the current embodiment of this invention.

FIG. 11 is a table giving an example of the data customers enter on the group buy website in order to place a bid on an item as per the current embodiment of this invention.

FIG. 12 is an example of a website used to facilitate group buys on a page where the customer selects which product to bid on as per the current embodiment of this invention.

FIG. 13 is an example of a website used to facilitate group buys on a page where the customer views the suggested retail value of the particular item they are bidding on and enters their bid price for the item and the quantity they desire to purchase as per the current embodiment of this invention.

FIG. 14 is an example of a website used to facilitate group buys on a page where the customer may view their cart before submitting their bid offer as per the current embodiment of this invention.

FIG. 15A is an example of a website used to facilitate group buys on a page where the customer enters their payment and shipping information as per the current embodiment of this invention.

FIG. 15B is an example of a website used to facilitate group buys on a page where the customer continues to enter their payment and shipping information and which also conveys to the customer that they will not be charged until the group buy is successfully completed as per the current embodiment of this invention.

FIG. 16 is an example of a website used to facilitate group buys on a page where the customer may view their pending offers as per the current embodiment of this invention.

FIG. 17 is an example of a website used to facilitate group buys on a page where the customer may cancel their pending orders as per the current embodiment of this invention.

FIG. 18 is an example of how a website used to facilitate group buys might display the progress of the group buy before the deal is closed as per the current embodiment of this invention.

FIG. 19 is an example of how a website used to facilitate group buys might display the progress of the group buy when the deal is successfully completed as per the current embodiment of this invention.

FIG. 20 is an example of how a website used to facilitate group buys might display the progress of the group buy if the deal fails due to the time limit being reached before the target is reached as per the current embodiment of this invention.

FIG. 21 is a screen capture of a website used to facilitate group buys on a page where the customer views the results of the group buy as it applies to their orders as per the current embodiment of this invention.

FIG. 22 is an example of a bottom navigation bar where a customer my access different pages as per the current embodiment of this invention.

### DETAIL DESCRIPTIONS OF THE INVENTION

All illustrations of the drawings are for the purpose of describing selected versions of the present invention and are not intended to limit the scope of the present invention.

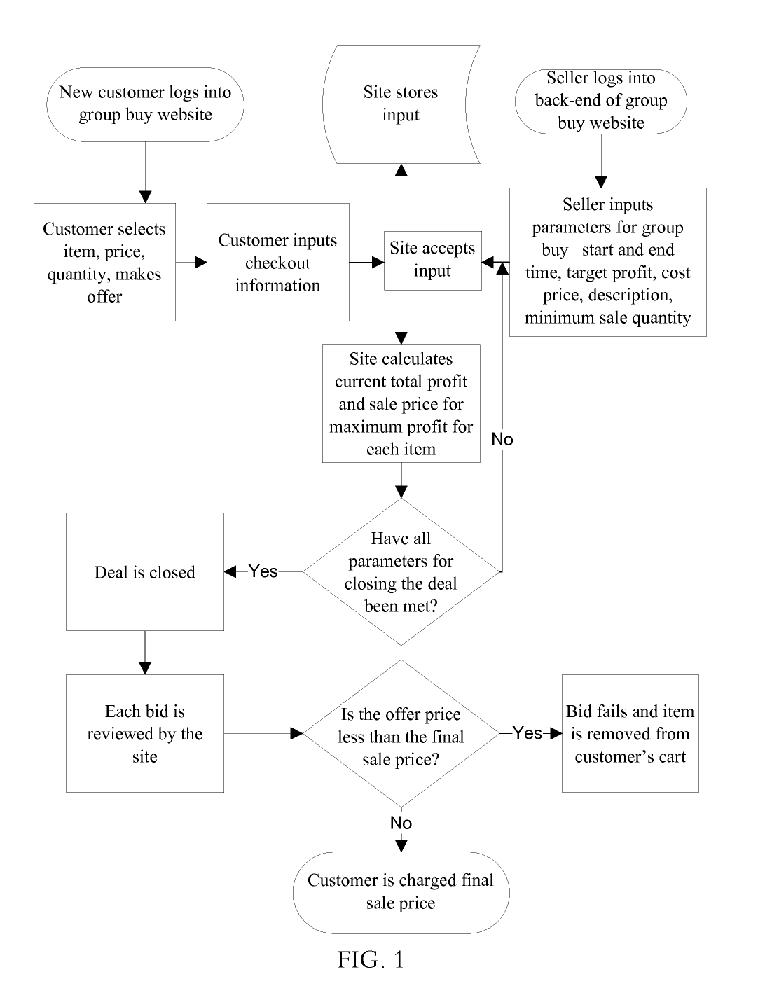

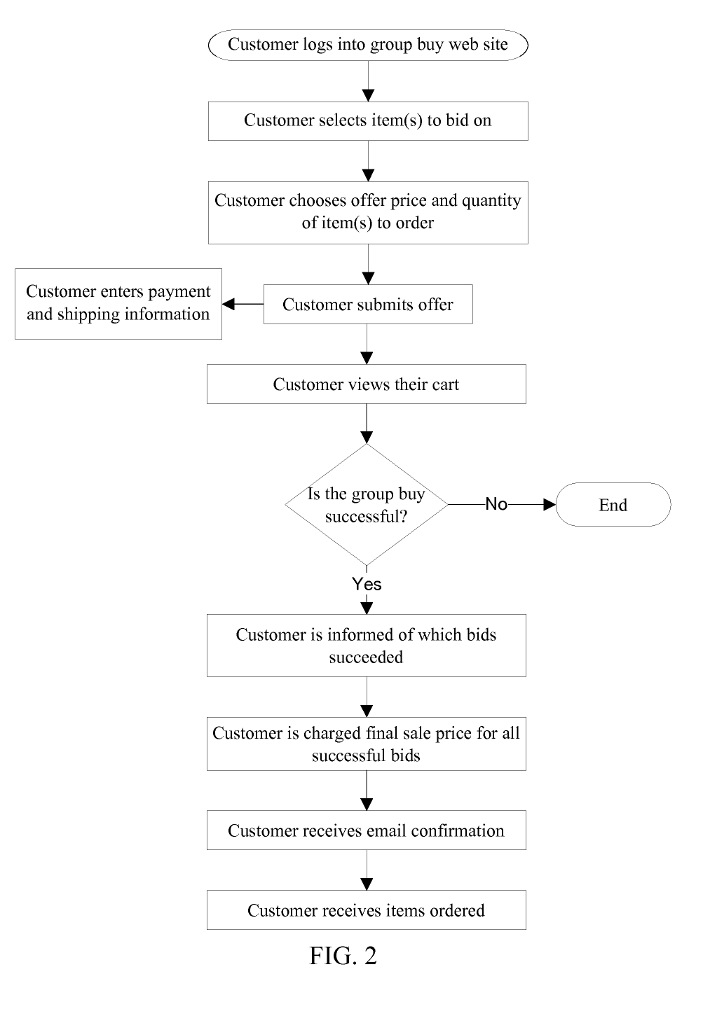

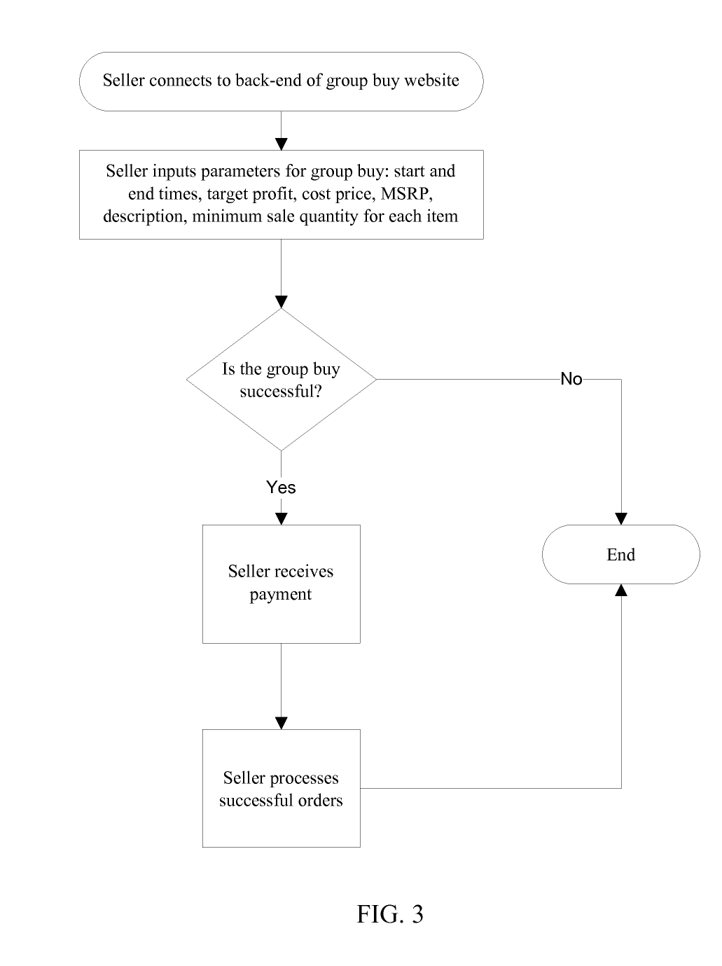

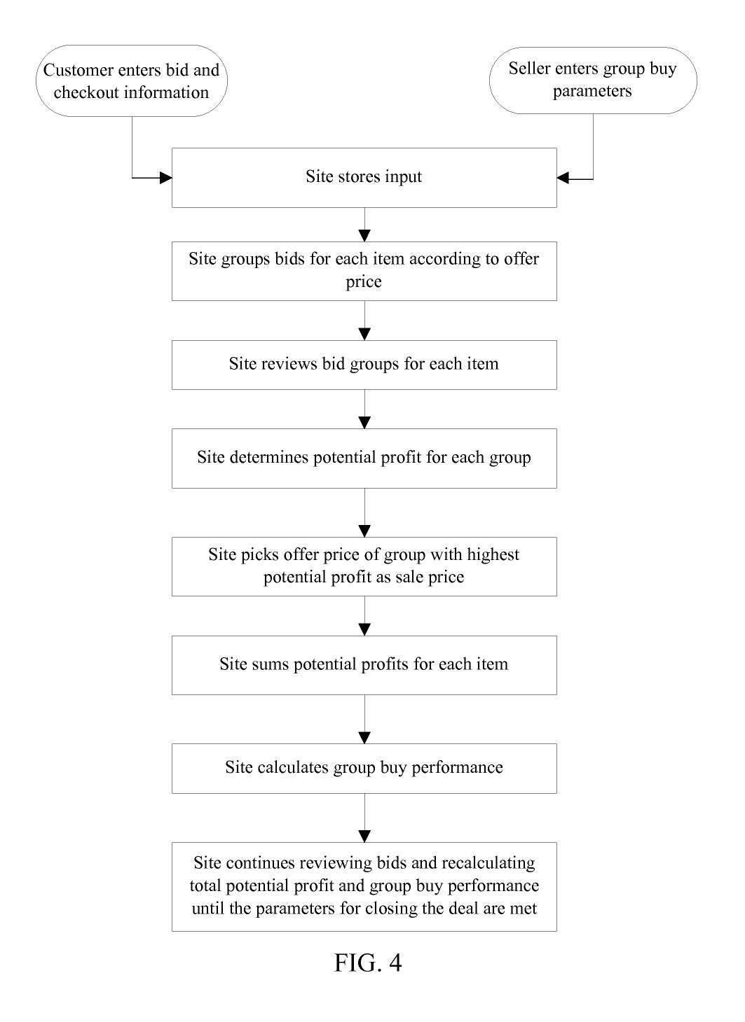

The present invention is a website that allows a merchant to organize a bulk sale with a group of interested buyers through an online auction system. This concept is also known as a group buy. A group buy provides advantages to both the merchant and consumers. A merchant benefits from moving inventory much more quickly than happens in traditional retail channels, while consumers benefit from bulk prices without having to purchase in bulk quantities. The present invention allows a merchant to organize a group buy which can then be accessed by interested buyers. The merchant, or seller, lists products for sale under a group buy. The interested buyers can join the group buy and place bids for any of the listed products. The group buy evaluates the bids submitted by the interested buyers and, once sale parameters entered by the seller have been met, the group buy is ended. At this point successful buyers are charged a final sale price and will receive a delivery of the products they bid on. The general process for the present invention is outlined in FIG. 1. A buyer's perspective of the process is illustrated in FIG. 2, while FIG. 3 depicts the process from a seller's viewpoint. Another outline of the general process is shown in FIG. 4.

To organize the group buy the seller, or admin, logs through a back-end of the website. As seen in FIG. 1, FIG. 3, and FIG. 4, after logging in the seller enters information relevant to the group buy. The relevant information includes a plurality of items to be sold as well as a plurality of sale parameters for each of the plurality of items. In effect, a group buy can be for only a single item, or a large number of items. While a seller can set up multiple group buys, each group buy is independent from other group buys set up by the seller. The plurality of sale parameters includes an item description, a sale duration, a target profit, a minimum sale quantity, a cost, and a manufacturer's suggested retail price (MSRP), partially represented in FIG. 3. The item description can be used to provide any information about the item that may be relevant to a buyer. The sale duration includes a start time and end time for the group buy and is automatically used for all of the items in the group buy. The target profit entered also applies to the group buy as a whole, being compared to a sum of profits (or current total profit) calculated from the profits of each of the plurality of items. The sale duration and target profit determine how long the group buy remains open; once the target profit is met, the group buy is successfully ended. If the sale duration expires without the target profit being ended, the group buy fails and no sales are made. The minimum sale quantity allows the seller to adjust for inventory; if there is a large amount of inventory to be moved, the seller can set a higher minimum sale quantity, although this runs the risk of having a failed group buy due to an insufficient amount of interested buyers. The cost is equal to the minimum sale price of the item and is used by the website as part of the calculations to determine if the current total profit matches or exceeds the target profit. The MSRP is provided solely for the benefit of the interested buyers. In other embodiments, if the seller does not know the MSRP, the website can suggest a MSRP to the seller. Alternatively, the MSRP could be omitted entirely. The target profit, minimum sale quantity, and cost are secret and not revealed to the buyers.

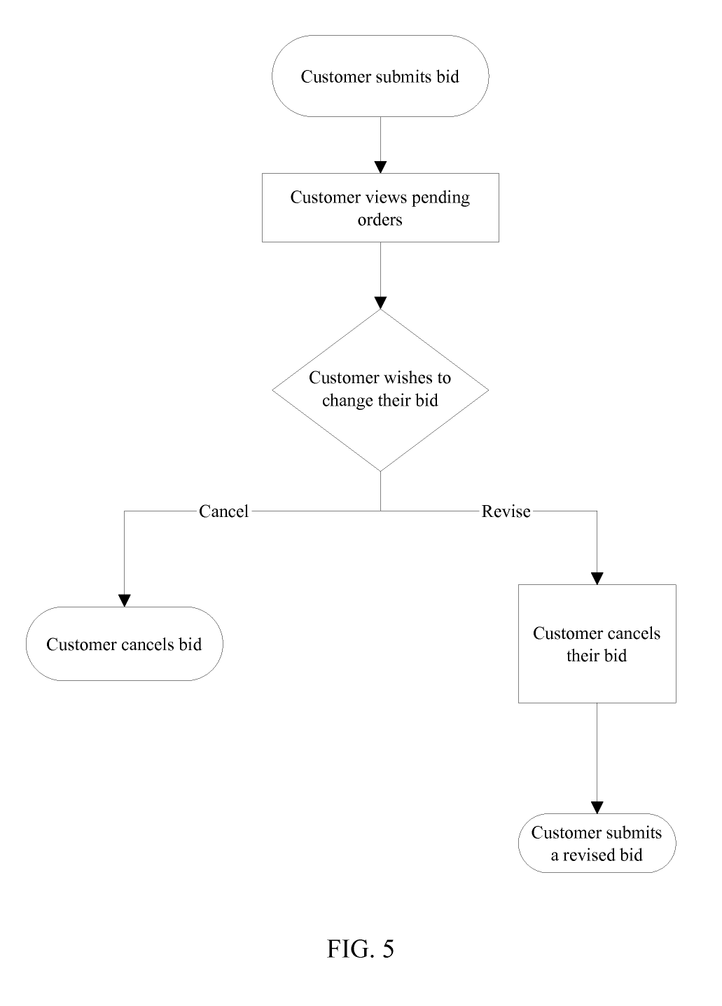

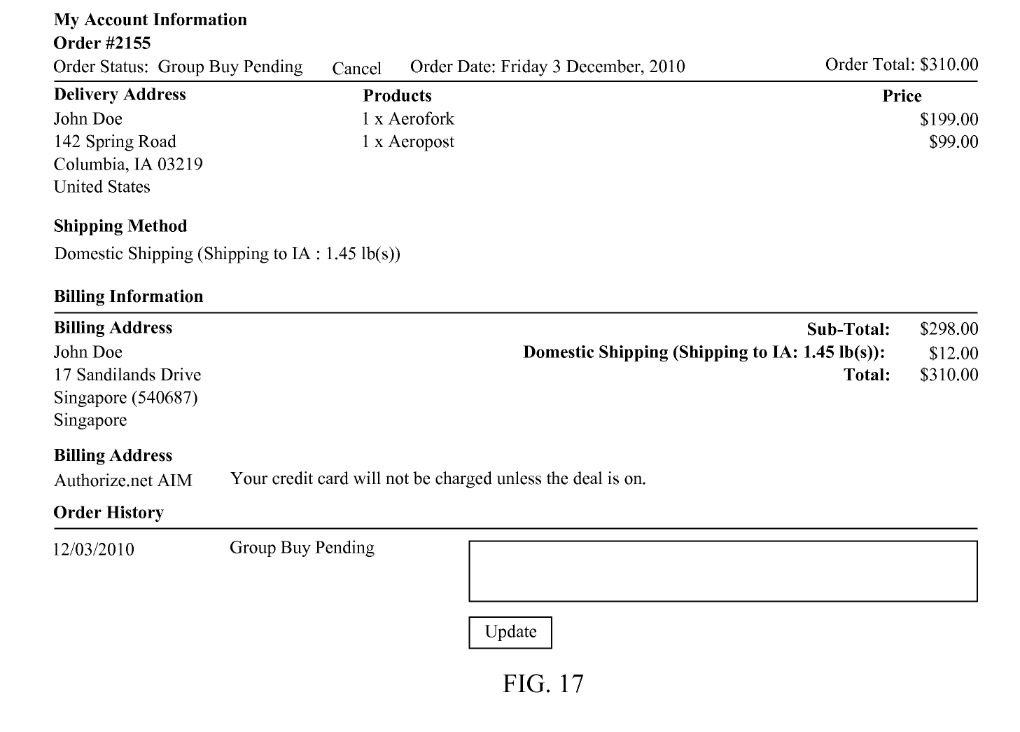

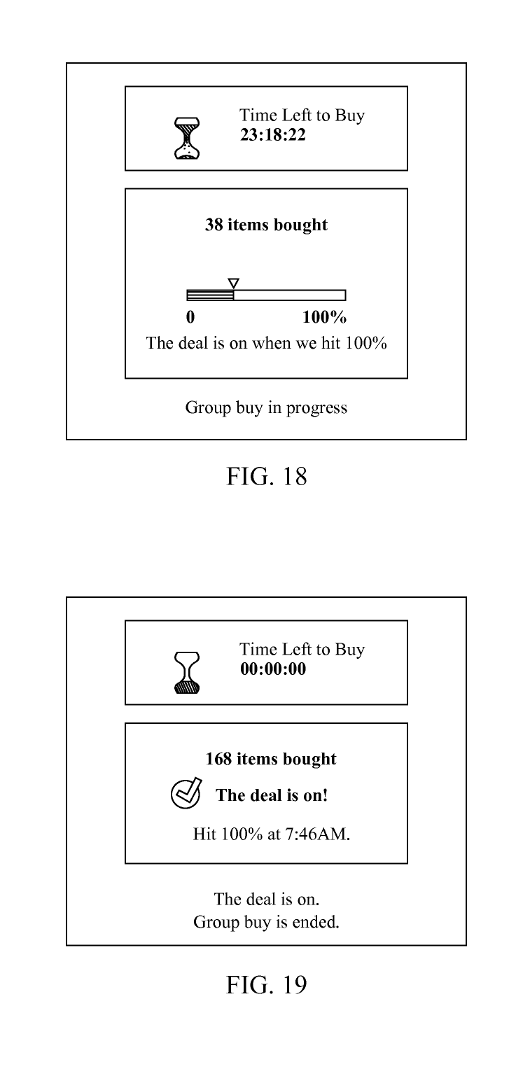

After the seller has created the group buy, customers may access a front-end of the website, as mentioned in FIG. 1 and FIG. 2. Interested buyers can choose to join an ongoing group buy to bid on items being offered. FIG. 5 provides an outline of the bidding process, including entering and revising bids. The website provides relevant information to the interested buyer to help decide what items to bid on and how much to bid. The bids are submitted in a predetermined single currency, using current currency exchange rates if the interested buyers use a different currency. The website informs the buyer of the item description, the MSRP, the remaining sale duration, a total purchase quantity showing how many items would be sold by the seller if the group buy is triggered, a progress towards reaching the target profit (as per FIG. 18), and whether or not the group buy has been successfully triggered. The interested buyer can use the status information to help decide how much to bid, or if it may be worthwhile to adjust the bid. The MSRP provides a guideline for an initial bid; a buyer will generally bid below the MSRP, since products usually sell for less than the MSRP except in situations of high demand. If a buyer knows that this particular product is in high demand, then the MSRP may be considered a good price. Essentially, the MSRP provides the interested buyer with a reference when deciding how much to bid. An interested buyer may choose to increase or decrease the amount bid depending on the remaining sale duration, the total purchase quantity, and the progress towards profit. For example, if the sale duration has almost expired but the progress towards profit indicates the target profit has almost been met, an interested buyer may choose to increase their bids in hopes of triggering the group buy before the sale duration expires. Alternatively, an interested buyer may choose to lower their bid if there is a large amount of time before the sale duration expires but the progress towards profit indicates the target has almost been met; in this case, it is possible that additional interested buyers will place bids, potentially allowing the interested buyer to successfully place a lower bid. If the interested buyer has already placed a bid, the website can provide the interested buyer with a reminder of which items were bid on, including the bid amount and purchase quantity. An example of this information is illustrated in FIG. 17. An interested buyer will only be able to review specific bid information and purchase quantities related to their own bids; the bids and purchase quantities of any individual interested buyer will only be visible to said interested buyer and the seller. In short, the interested buyers are completely anonymous except to the seller. Other information that will not be displayed to the interested buyer includes the cost and the minimum sale quantity, which would allow the buyer to determine the lowest possible price they can bid, effectively undercutting the bidding process.

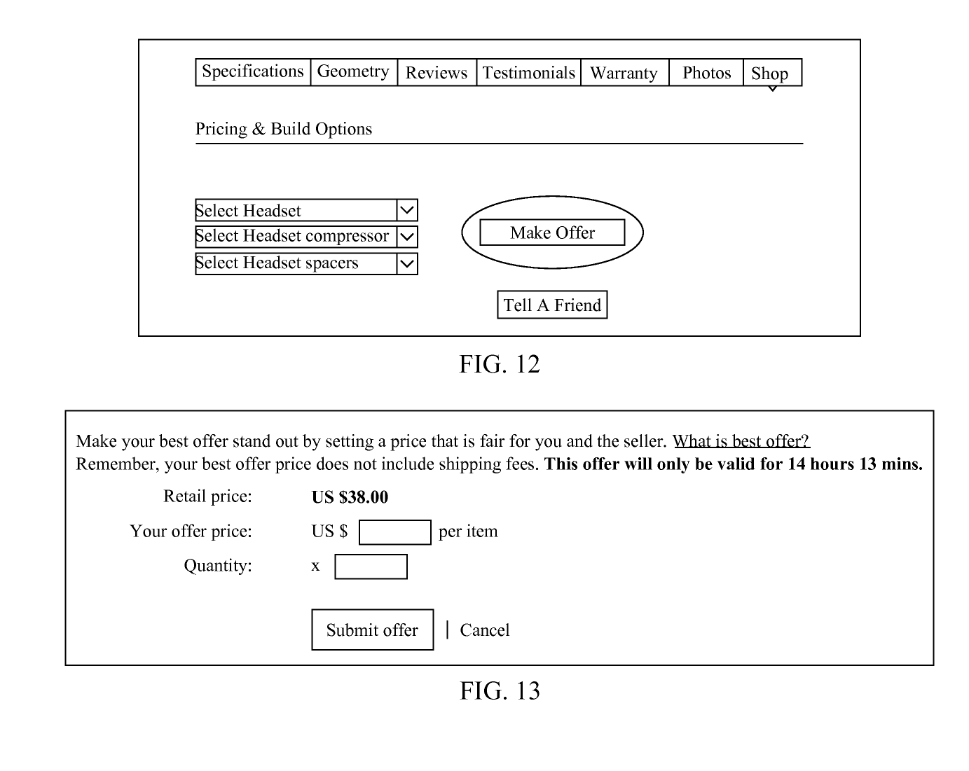

After reviewing the current status of the group buy, the interested buyer may select (as in FIG. 12) one, some, or all of the items being offered in the group buy, entering a bid for each item the interested buyer wants to purchase, like illustrated in FIG.

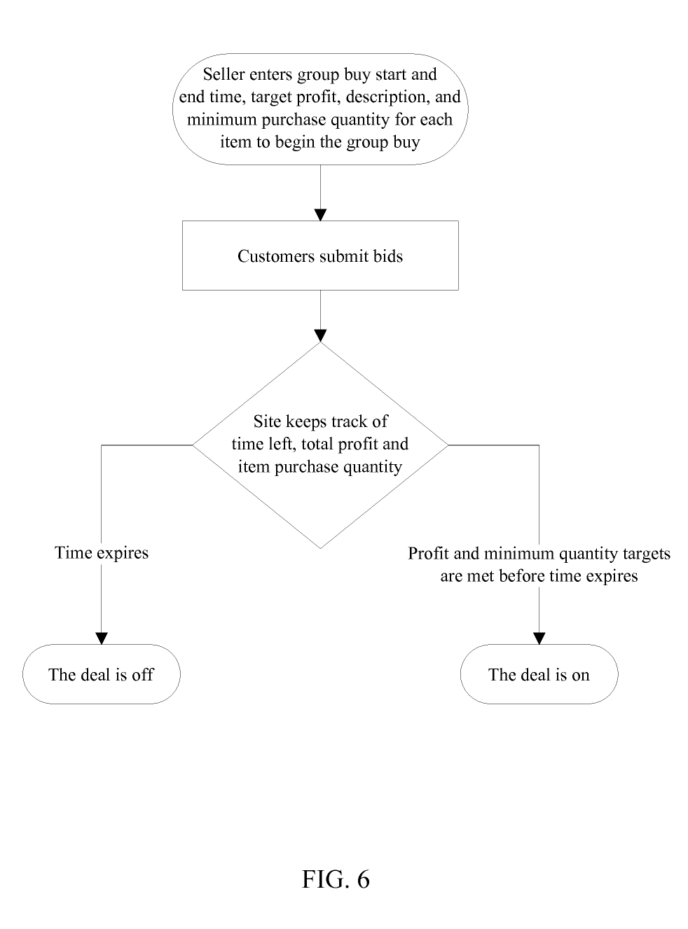

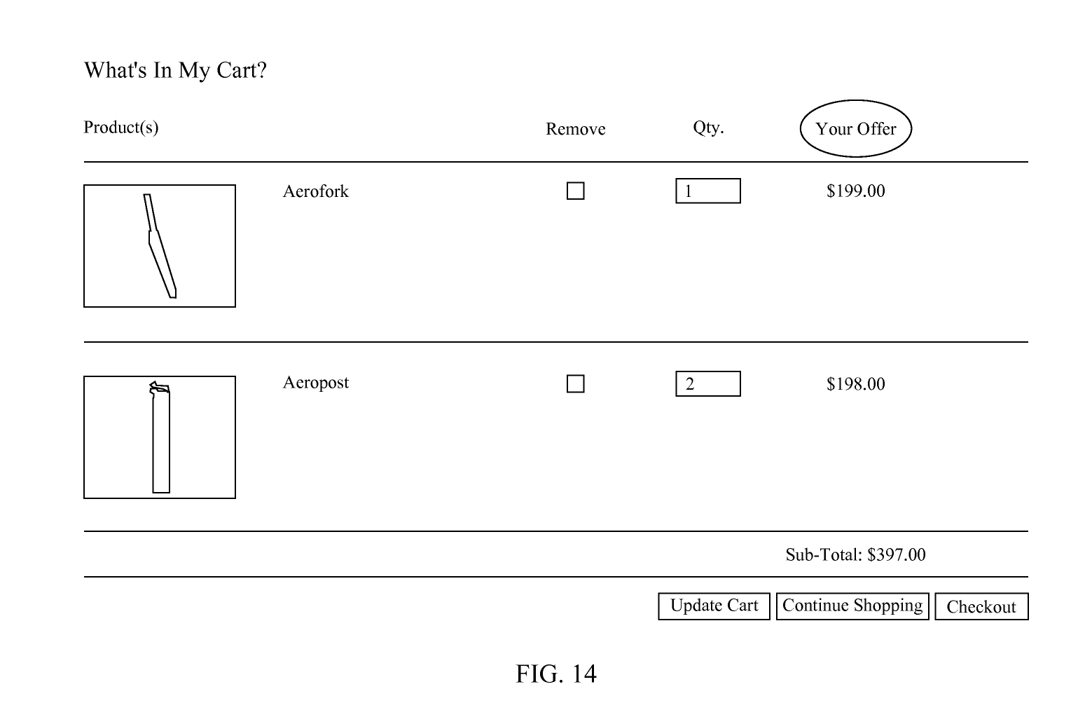

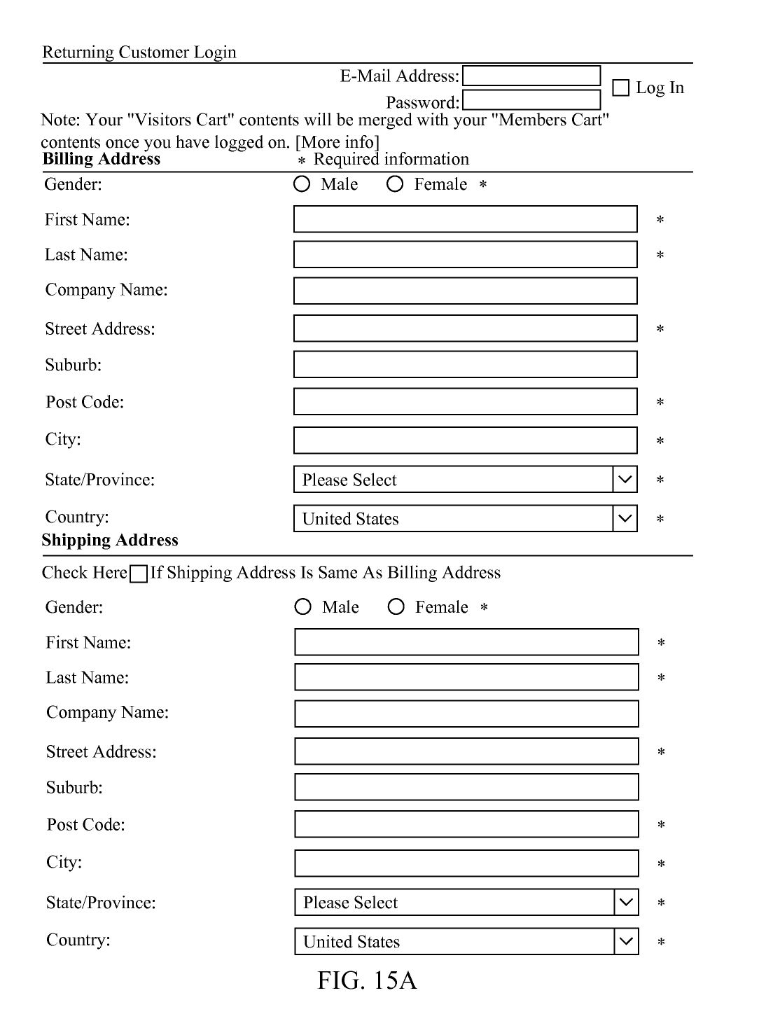

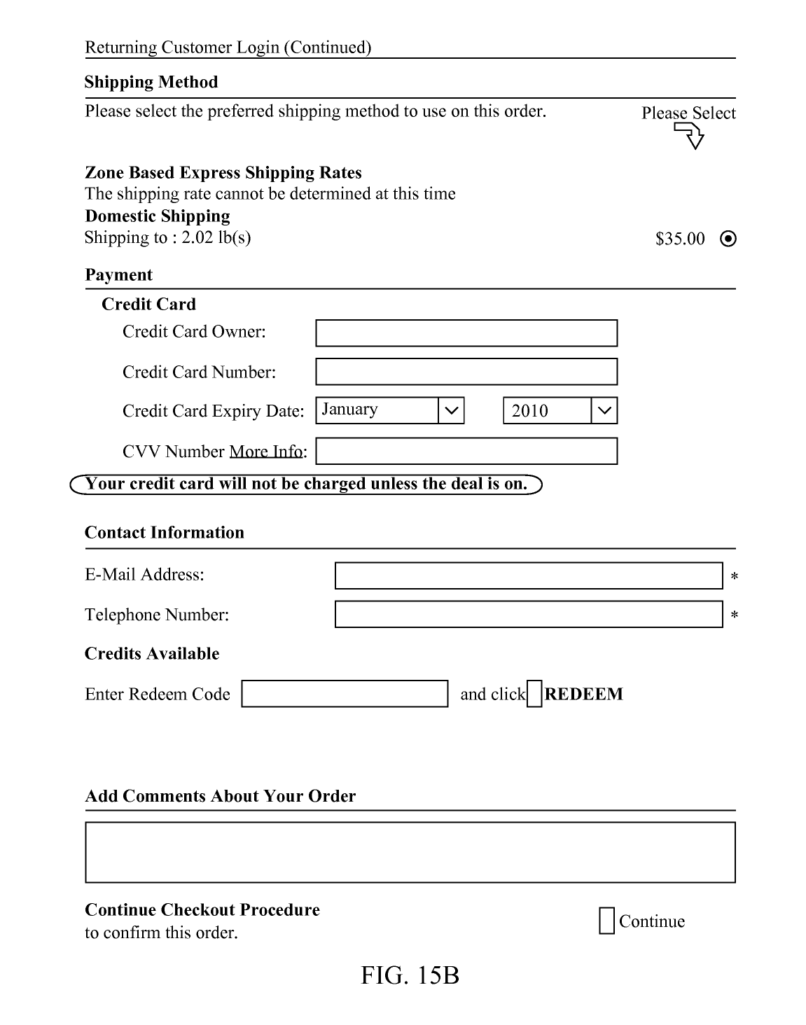

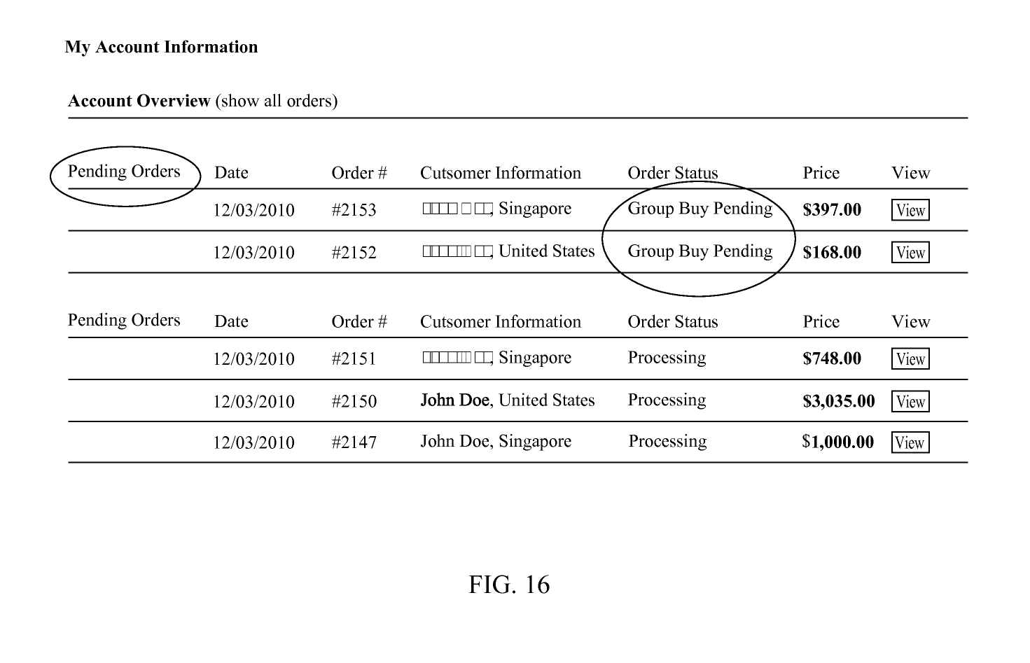

5 and FIG. 6. In addition to entering bids for the items, the interested buyer also enters a purchase quantity for each of the desired items, shown in FIG. 13 and FIG. 14. Once the website receives the bids and purchase quantities from the interested buyers, the interested buyers are prompted to enter and confirm a credit card number and a shipping address, depicted in FIG. 15A and FIG. 15B. After verifying the credit card number and shipping address this checkout information is stored in a database. The credit card is not charged at this point, and the checkout information will only be used if the interested buyer's bids are confirmed as successful at the end of the group buy. At any time a buyer may view their pending orders, such as in FIG. 16.

If an interested buyer is no longer interested in a particular item, the interested buyer may cancel their bid, outlined in FIG. 5. An interested buyer may only cancel their bid if the group buy has not ended; if the group buy has ended due to the target profit being met, the interested buyer may no longer cancel their bid. If the group buy ends because the sale duration expires, then the group buy fails and the interested buyer is not charged; in this situation, the interested buyer is not charged regardless if their bid is cancelled or not. If an interested buyer wishes to adjust their bid, also outlined in FIG. 5, they must cancel their current bid. After canceling their current bid, the interested buyer may then submit a new bid and purchase quantity. The website will discard the original bid, only using the new bid when determining if the target profit has been met.

At any point during the group buy, the seller has the option to view all current bids from the interested buyers. This information can be presented in a variety of forms, such as a summary table. The summary table includes a separate column for the item, as well as a corresponding column with a sale price SN, a quantity QN, and a max profit PN. The table includes N rows, where N is equal to the number of items being sold in the group buy.

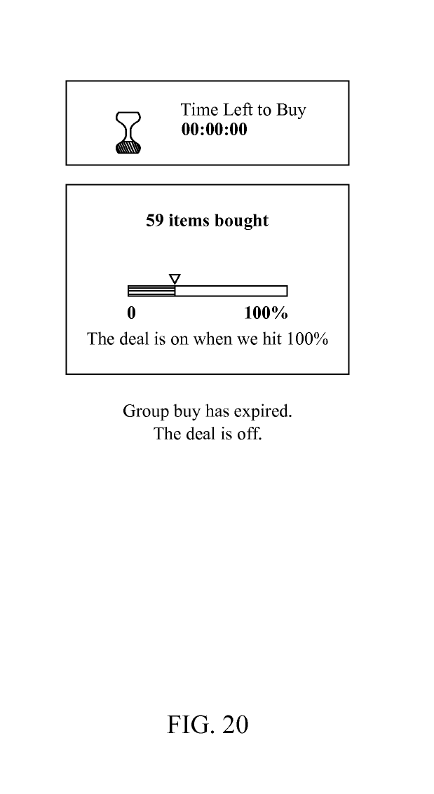

The group buy is considered to be “on”, or successfully triggered, if the target profit and minimum sale quantity are met before the sale duration expires. In this situation, seen in FIG. 19, the group buy is ended successfully. Once the group buy is on interested buyers who have successfully placed bids will be billed the appropriate amount. The seller will have the items shipped to the provided shipping addresses of the successful interested buyers. If the sale duration expires without the target profit and the minimum sale quantity being met, then the group buy is considered “off”, or unsuccessful. If the group buy is unsuccessful, as in FIG. 20, no transactions take place; interested buyers are not charged, and the seller does not ship out products. Though it is theoretically possible for the target profit to be met without meeting the minimum sale quantity, it is assumed that such a situation would never occur since the interested buyers would have to be bidding much higher than the MSRP.

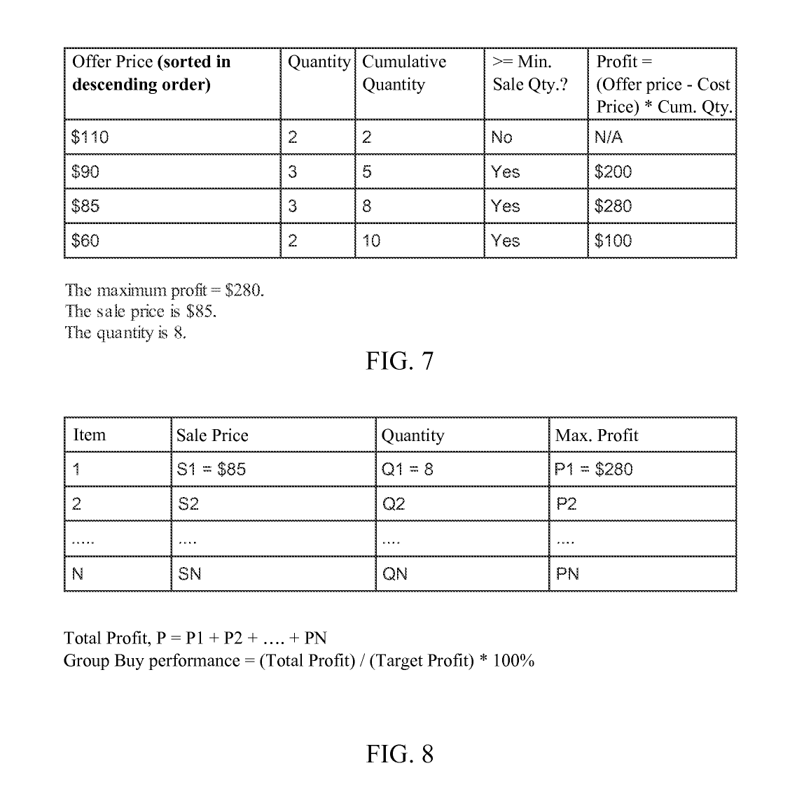

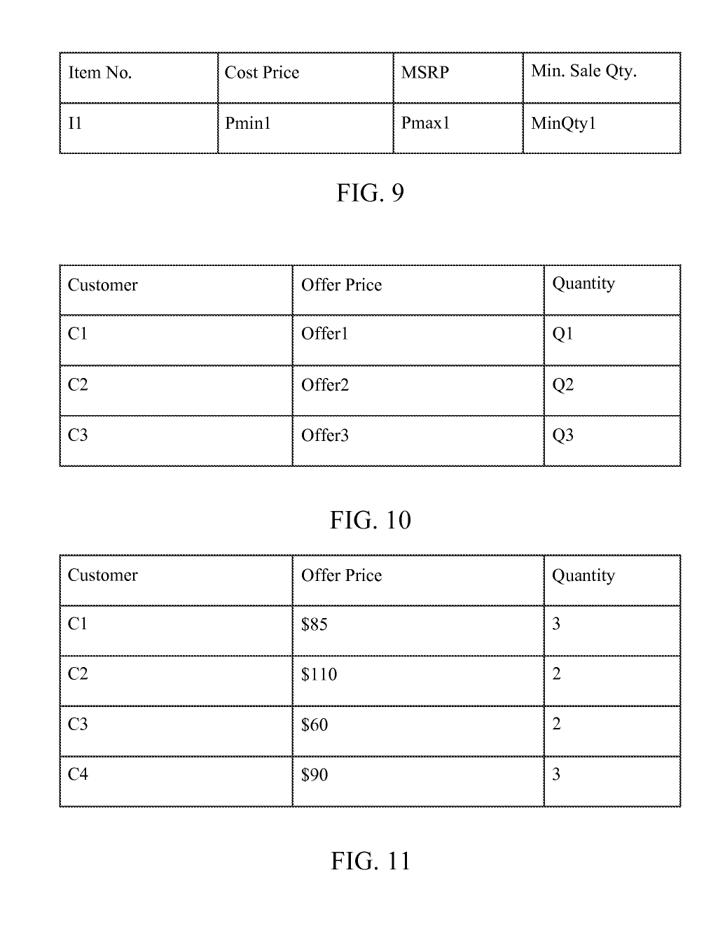

Every time an interested buyer submits a bid or cancels an existing bid the system calculates the status of the group buy. When determining the status of the group buy the system evaluates all of the bids and determines the maximum possible profit. The system determines the maximum profit by evaluating and summing potential profits for each of the items being sold. The system does this by creating groups based on the bids placed by the interested buyers, as explained in FIG. 7 and FIG. 8, and comparing the bids with stored data from the seller and interested buyers, illustrated in FIG. 9, FIG. 10, and FIG. 11.

A first group is created, with this first group including the highest bid. If multiple interested buyers are tied for the highest bid, the first group includes each of these interested buyers as members. The first group is assigned a group bid value equal to the bid placed by the included members. The first group is also assigned a group net purchase quantity equal to the sum of the purchase quantities of the included members. The system then compares the net purchase quantity to the minimum sale quantity. If the net purchase quantity is not equal to or greater than the minimum sale quantity, the system determines the group to be ineligible, since the group does not meet all of the sale parameters. If the net purchase quantity is equal to or greater than the minimum sale quantity, the system calculates a group net profit. The group net profit is calculated by first subtracting the cost of the item from the group bid value. The resultant value is then multiplied by the net purchase quantity, resulting in a final value for the group net profit. The group net profit represents how much money the seller would make (subtracting for the costs of the item) if the sale was made to the current group. FIG. 7 and FIG. 8 show the calculations and comparisons for example groups.

After evaluating the first group, the system calculates group profits for a second highest bid (a second group), third highest bid (a third group), and so on until the lowest bid (a last group). The group bid value for each of these groups is equal to the second highest bid, the third highest bid, and correspondingly to the lowest bid. A group is created and evaluated for each unique bid that is submitted by the interested buyers. For example, if bids of $100, $95, $80, $80, and $77 are received, there would be a total of four groups. Even though there are five bids, two of the bids are for the same value, and no two groups can share the same group bid value.

When calculating group net profits for the second and later groups, the group members are determined similarly to the first group; the group includes all interested buyers who placed a bid equal to the group bid value. In addition, the group includes all interested buyers who placed a bid greater than the group bid value. Returning to the previous example, the second group would include the interested buyers who submitted bids of $95 and $100 as members. Even though the second group bid value is $95, $100 is higher and so the interested buyer who submitted that bid is still included in the second group. Effectively, the interested buyer who submits the highest bid will be included in every group, although the interested buyer will not be aware of the bids of other buyers.

The calculation for the group net profits of the second and later groups continues similarly to the process for the first group. A net purchase quantity is equal to the sum of the included members; remember that this includes interested buyers who place a bid higher than the group bid value. In the provided example, the second group would sum the purchase quantities of the interested buyer with the $100 bid and the interested buyer with the $95 bid to obtain the net purchase quantity. As with the first group, if this net purchase quantity is lower than the minimum sale quantity, the group is considered ineligible. If the net purchase quantity is greater than the minimum sale quantity, the total group net profit is equal to the product of multiplying the group bid value by the difference of the cost and the group bid value.

After the system calculates group profits for each of the groups, the system discards any of the ineligible groups (groups that had a net purchase quantity less than the minimum sale quantity, such as the first group in FIG. 7) and compares the group net profits of the remaining eligible groups. The system selects the highest group net profit to be used in calculating the current total profit. The system repeats the group net profit calculations for each item being sold in the group buy, selecting a highest group net profit to represent each item, as illustrated in FIG. 7. The highest group net profits, one for each item, are summed to obtain the current total profit. Effectively, the total profit is based on the current potential maximum profits for each item and can be described, like in FIG. 8, as P=P1+P2+. . . +PN, where P is defined as the total current profit and PN is the potential maximum profit for an item N. The current total profit can be represented as a percentage of total profit, defining the group buy performance (sale progress) to be equal to the [(current total profit)/(target profit)]*100%.

In other embodiments, the calculation can be altered, perhaps using a non-linear equation, to make it more difficult for interested buyers to derive the target profit and minimum purchase quantity, information which would allow the interested buyer to abuse the group buy. In addition, the group buy performance is calculated at predetermined intervals, such as an hour. This is another measure to prevent interested buyers from figuring out the target profit and minimum purchase quantity, which could be derived if submitting or cancelling bids changed the group buy performance instantly. As more interested buyers join the group buy and make new bids, or if an interested buyer revises their bid to have a higher offer price or larger purchase quantity, the group buy performance increases. If a customer revises their bid such that the offer price or purchase quantity is lower, the group buy performance decreases. The current total profit is compared to the target profit; if the current total profit equals or exceeds the target profit, and the sale duration has not expired, the group buy successfully ends. Since groups with a purchase quantity less than the minimum sale quantity are not included in the profit calculations, the system knows that the minimum sale quantity has also been met if the current total profit is above the target profit.

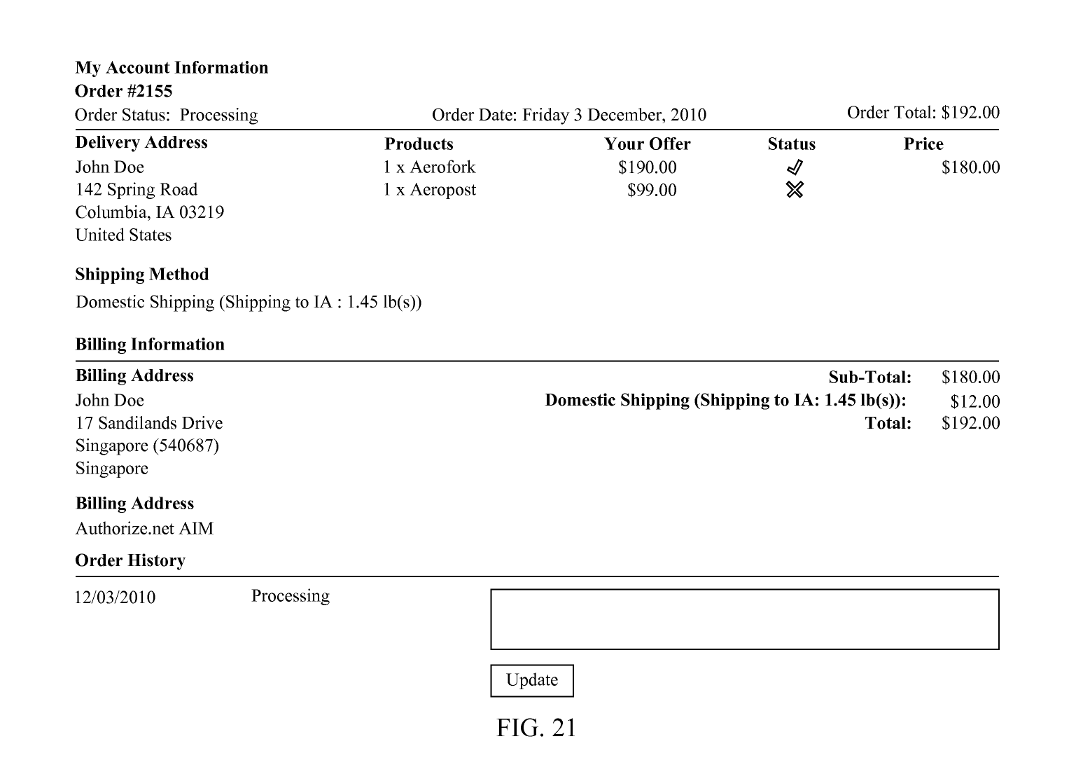

As soon as the group buy performance becomes greater than or equal to 100%, illustrated in FIG. 19, the deal is on. The website determines a sale price for each of the items being sold, with the sale price being equal to the group bid value from the group with the highest group net profit. Then, as shown in FIG. 21, the system then reviews each bid from the interested buyers. If the bid is equal to or greater than the sale price, the interested buyer successfully purchases the item, and is charged a total amount equal to the final sale price multiplied by the buyer's purchase quantity, plus shipping and handling fees, if any. If an interested buyer's bid is less than the final sale price, the item is removed from the interested buyer's cart. Order confirmation emails are then sent to all the interested buyers with the details of their bid(s), describing which of their bids were successful and the final sale price for each of the items they successfully bid on. The items which were successfully bid on are then processed and completed by the seller.

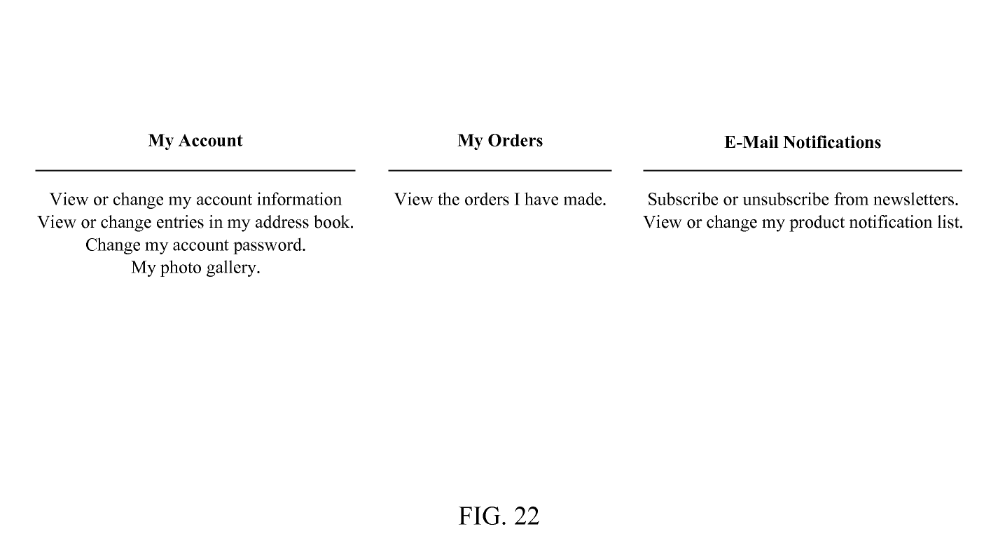

The website for the present invention should be designed with a usable interface to facilitate auction listings and bidding. This includes providing hotlinks to individual pages which users will frequently use. An example of this is shown in FIG. 22, which provides a user with links across the bottom of a page, allowing easy access to pages that will be frequently used. The website could be designed with alternate layouts, or provide different hotlinks, depending on the preferences of the host and users. Potentially, the website could even allow users to select from different display options, providing each user with a theme best suited to said user's preferences.

Although the invention has been explained in relation to its preferred embodiment, it is to be understood that many other possible modifications and variations can be made without departing from the spirit and scope of the invention as hereinafter claimed.

What is claimed is:

1. A method for initiating a group buy by executing computer-executable instructions stored on a non-transitory computer-readable medium, the method comprises the steps of:
providing a seller account and a plurality of buyer accounts;
providing a website, wherein a group buy is hosted on the website;
receiving an initial request from the seller account to create the group buy, wherein the group buy provides a means for the seller account to make a bulk sale to the plurality of buyer accounts;
prompting the seller account to enter a plurality of items to be sold;
prompting the seller account to enter a plurality of sale parameters for each of the plurality of items, wherein the plurality of sale parameters includes an item description, a sale duration, a target profit, a minimum sale quantity, a cost, and a manufacturer's suggested retail price (MSRP);
receiving a join request to participate in the group buy from an interested buyer from the plurality of buyer accounts, wherein the interested buyer joins a plurality of interested buyers;
receiving a purchase request from the plurality of interested buyers to purchase an at least one item from the plurality of items;
prompting the plurality of interested buyers to enter a plurality of purchase parameters, wherein the purchase parameters include a bid and a purchase quantity;
prompting the plurality of interested buyers to enter checkout information;
notifying the seller account and the plurality of buyer accounts of a status update of the group buy by compiling the plurality of sale parameters and the plurality of purchase parameters, wherein the status update reports a remainder of the sale duration, the purchase quantity, and a sale progress;
evaluating a sale status of the group buy by creating and comparing a plurality of groups from the plurality of interested buyers, wherein a group bid value, a group net purchase quantity, and a group net profit are determined for each of the plurality of groups;
calculating the group net profit using a sale price, the group net purchase quantity, and the cost;
determining a current total profit by summing the group net profit from each of the plurality of items;
terminating the group buy with a successful sale by billing the plurality of interested buyers,
if the plurality of sale parameters is satisfied; and
terminating the group buy with a failed sale,
if the plurality of sale parameters is not satisfied.

2. The method for initiating a group buy by executing computer-executable instructions stored on a non-transitory computer-readable medium, the method as claimed in claim 1, wherein the seller account accesses a backend of the website and the plurality of buyer accounts access a frontend of the website.

3. The method for initiating a group buy by executing computer-executable instructions stored on a non-transitory computer-readable medium, the method as claimed in claim 1 comprises the steps of:
prompting the seller account to enter the item description for each of the plurality of items;
prompting the seller account to enter the sale duration for the plurality of items, wherein each of the plurality of items has the same sale duration;
prompting the seller account to enter the target profit for the group buy;
prompting the seller account to enter the minimum sale quantity for each of the plurality of items;
prompting the seller account to enter the cost for each of the plurality of items; and
prompting the seller account to enter the MSRP for each of the plurality of items.

4. The method for initiating a group buy by executing computer-executable instructions stored on a non-transitory computer-readable medium, the method as claimed in claim 1 comprises the steps of:
notifying the plurality of interested buyers of the MSRP for the at least one item;
prompting the plurality of interested buyers to enter the bid for the at least one item; and
prompting the plurality of interested buyers to enter the purchase quantity for the at least one item.

5. The method for initiating a group buy by executing computer-executable instructions stored on a non-transitory computer-readable medium, the method as claimed in claim 1 comprises the steps of:
providing a credit card number and a shipping address as the checkout information;
prompting the plurality of interested buyers to enter the credit card number; and
prompting the plurality of interested buyers to enter the shipping address.

6. The method for initiating a group buy by executing computer-executable instructions stored on a non-transitory computer-readable medium, the method as claimed in claim 5 comprises the steps of:
displaying the credit card number to the plurality of interested buyers in order to confirm the credit card number; and
displaying the shipping address to the plurality of interested buyers in order to confirm the shipping address.

7. The method for initiating a group buy by executing computer-executable instructions stored on a non-transitory computer-readable medium, the method as claimed in claim 1 comprises the steps of:
receiving a cancel request from the plurality of interested buyers; and
discarding the bid and the purchase quantity to comply with the cancel request.

8. The method for initiating a group buy by executing computer-executable instructions stored on a non-transitory computer-readable medium, the method as claimed in claim 1 comprises the steps of:
sending a notification to remind the plurality of interested buyers of a remainder of the sale duration for each of the plurality of items;
sending a notification to remind the plurality of interested buyers of the purchase quantity for each of the plurality of items;
sending a notification to remind the plurality of interested buyers of the sale progress of the group buy by creating a comparison between the current total profit to the target profit; and
providing a visual representation of the comparison by displaying a progress bar representing the current total profit as a percentage of the target profit.

9. The method for initiating a group buy by executing computer-executable instructions stored on a non-transitory computer-readable medium, the method as claimed in claim 1 comprises the steps of:
creating a plurality of groups based upon the bids to determine the sale price;
assigning each of the plurality of groups with a group bid value, wherein none of the plurality of groups shares a group bid value;
selecting the group bid value from the bids of the plurality of interested buyers;
determining the group net purchase quantity by summing up the purchase quantity of each of the bids;
assigning each of the plurality of groups with a group net purchase quantity;
if the bid is equal to or greater than the group bid value;
selecting a plurality of eligible groups with a group net purchase quantity equal to or greater than the minimum sale quantity;
discarding a plurality of ineligible groups with a group net purchase quantity less than the minimum sale quantity;
determining the group net profit by subtracting the cost from the group bid value and multiplying a result by the group net purchase quantity;
assigning each of the plurality of eligible groups with a group net profit;
selecting a highest group net profit from the plurality of eligible groups;
assigning the group bid value corresponding to the highest group net profit as the sale price; and
terminating the group buy if the current total profit is equal to or greater than the target profit.

10. The method for initiating a group buy by executing computer-executable instructions stored on a non-transitory computer-readable medium, the method as claimed in claim 1 comprises the steps of:
comparing the bid from the plurality of interested buyers to the sale price for each of the plurality of items to determine whether the plurality of interested buyers successfully purchased each of the plurality of items;
billing the plurality of interested buyers a final price if the bid is equal to or greater than the sale price; and
determining the final price for each of the plurality of interested buyers by multiplying the sale price by the purchase quantity of each of the plurality of items and calculating the total sum.
